(19) United States
(12) Patent Application Publication
(10) Pub. No.: US 2010/0330438 A1
(43) Pub. Date: Dec. 30, 2010

(54) PASSIVE DILUTION UNIT FOR DILUTING FUELS

(76) Inventor: Michael Oszcipok, Freiburg (DE)

Correspondence Address: JACOBSON HOLMAN PLLC, 400 SEVENTH STREET N.W., SUITE 600, WASHINGTON, DC, 20004, US

(21) Appl. No.: 12/734,314

(22) PCT Filed: Oct. 13, 2008
(86) PCT No.: PCT/EP2008/008649

§ 371 Date: Aug. 31, 2010

(30) Foreign Application Priority Data
Oct. 23, 2007 (DE) 10 2007 050 616.5

(51) Int. Cl. H01M 8/06; C10L 1/182

(52) U.S. Cl. 429/408; 44/639; 44/451

(57) ABSTRACT

The present invention relates to a passive dilution unit which has a throughflow channel for fuel, the throughflow channel having at least one window in which a membrane provided with a catalyst is fitted. By means of diffusive processes, for example atmospheric oxygen can penetrate through the membrane to the fuel flow and cause a reaction by means of oxidative processes imparted by the catalyst, in which reaction the fuel is oxidised into water. The thereby resulting water is retained directly in the fuel flow and thereby directly dilutes the fuel.

The present invention relates to a passive dilution unit which has a throughflow channel for fuel, the throughflow channel having at least one window in which a membrane provided with a catalyst is fitted. By means of diffusive processes, for example atmospheric oxygen can penetrate through the membrane to the fuel flow and cause a reaction by means of oxidative processes imparted by the catalyst, in which reaction the fuel is oxidised into water. The thereby resulting water is retained directly in the fuel flow and thereby directly dilutes the fuel.

For applications in energy technology, such as for example fuel cells, frequently liquid or gaseous hydrocarbons, e.g. alcohols, petrol etc., are used as fuels. These can be converted for example directly electrochemically into electrical energy, e.g. with fuel cells, or are further processed to form fuels of higher valency for example by reforming into hydrogen. Additional water is frequently required as reaction partner for these technical processing conversion steps in order to allow the conversion to take place. This water must either then be metered separately from a tank or the fuel is stored in a form diluted with water in a tank. In both processes, either a further separate tank is hence required or fuel must be stored already in diluted form. This hence involves the disadvantages that additional unnecessary tanks must be present or that the tank must have greater dimensions in order to hold the same quantity of fuel.

In previous commercial plants, water was either stored in a separate tank or it was mixed with the fuel. For direct alcohol fuel cells it is known that resulting product water can be introduced again into the fuel inflow, as a result of which a dilution with water which is necessary for the reaction can be achieved.

It is therefore the object of the present invention to provide a dilution unit for diluting fuels which is structured as simply as possible and can be operated as far as possible free of maintenance.

This object is achieved by the features of patent claim 1. With patent claim 9, a method for passive dilution of a fuel is indicated, whilst, with claims 16 or 17, application units, including the dilution unit, e.g. a reformer or a fuel cell, are mentioned. Application possibilities are mentioned in claim 20. The respective dependent claims thereby represent advantageous developments.

According to the invention, a dilution unit is hence provided for passive dilution of fuels with water, including at least one throughflow channel for fuel, the throughflow channel being configured at least in regions as a phase having at least one catalyst.

The proposed system is able to dilute highly concentrated fuels, such as for example alcohols, without mechanically moving components or additional water tanks being required. As a result, the technical complexity of the plant is reduced, the user must merely fill the fuel tank when the fuel is consumed and not additionally a water tank. It is possible with the invention to produce locally different water concentrations in the flow direction, corresponding to the locally required concentration. In the case of solutions with a separate water tank, only the input concentration can be adjusted, however, in the further course, influence can no longer be brought to bear on the concentration in the flow direction.

In the case of a stationary operation of a technical processing plant which contains such a unit, the fuel dilution is adjustable by dimensioning of the dilution unit itself.

Advantageously, the phase thereby comprises a membrane or a woven fabric, there being used here in particular plastic materials which are resistant to the fuel, such as e.g. polyetheretherketones such as sPEEK or PEEK, polytetrafluoroethylene (PTFE) and/or comparable high temperature-resistant or impact-resistant thermoplastics, ceramic materials, coated woven fabrics, semi-permeable membranes, porous membranes and/or ion-exchanger membranes.

The catalyst is thereby advantageously applied on the phase, i.e. for example on the membrane or on the woven fabric, in that the phase is coated and/or impregnated with the catalyst.

The catalysts used for the oxidation are hereby subject to no general restriction, rather the person skilled in the art can select them on the basis of his expert knowledge as a function of the fuel which is used.

Advantageously, catalysts are however selected here from the group comprising platinum, tin, ruthenium, osmium, cobalt, iron, nickel, rhodium, copper, zinc, chromium and/or alloys and/or combinations hereof. There is understood for example by combinations that a region of the catalyst is formed from a metal or from an alloy, whereas another region comprises another metal or another alloy. The catalyst can thereby be configured in particle form, pallet form, as a porous solid body or as a net.

The phase is configured here in particular such that it is permeable diffusively for gases.

In a preferred embodiment, the gases are thereby selected from the group comprising gaseous oxidants, preferably oxygen or air and/or gaseous reaction products, preferably carbon dioxide which penetrates the phase diffusively in the direction of the fuel flow, on the other hand, the gases can also be gaseous reaction products, preferably carbon dioxide, which diffuse outwards away from the fuel flow through the phase.

A further preferred property of the phase is a reduced permeability for water, for the fuel and/or for the fuel mixture, or a permeability which is vanishingly low for water, i.e. quasi none.

According to the invention, a method is likewise provided for passive dilution of a fuel or of a fuel mixture with water, a flow of a concentrated fuel or of a concentrated fuel mixture being guided past a phase having at least one catalyst and thereby at least a part of the fuel or of the fuel mixture being contacted with the phase and the catalyst, at least one oxidant being supplied to the phase via diffusive processes, a part of the fuel or of the fuel mixture being oxidised catalytically with water formation and the water resulting during the reaction diluting the fuel or the fuel mixture. The resulting water is therefore retained directly in the fuel flow and dissolved or emulsified in the latter. In particular the dilution unit discussed in the above is thereby used. It is hereby essential to the invention that the water resulting during the oxidative process is retarded in the fuel flow, direct dilution of the fuel flow therefore resulting. Differently from what is known from the state of the art, the requirement for water to be metered to the fuel flow via supply pipes or for water in fact to be produced by an oxidative process (e.g. in a fuel cell) is thereby dispensed with, however it must nevertheless be added again to the fuel flow by further pipes.

The fuel is hereby subject to no particular restriction apart from the fact that it can release water by means of oxidative processes. In particular, the fuel is selected from the group comprising liquid and/or gaseous fuels and/or mixtures hereof. There must be mentioned hereby as particularly preferred examples: hydrocarbons, such as e.g. natural gas, petrol, diesel, kerosene, methane, ethane, propane, butane, hydrogen, biogas, biodiesel, plant oils; alcohols, such as e.g. methanol, ethanol, denaturated alcohols, potable alcohol and/or mixtures hereof.

The method is thereby implemented in particular such that the fuel mixture is diluted up to the stoichiometrically required water content. There should hereby be understood that the water content is adjusted by the passive dilution method so that it must correspond to the optimised water content of a process subsequent to the dilution unit, for example a reforming process. It is hereby essential that the water content assumes very specific stoichiometric ratios with respect to the fuel content in order to be able to achieve optimum yields and reaction courses in the subsequent reforming process.

According to the invention, units which likewise further process or consume the fuel, such as for example a reformer or a fuel cell, are provided, these units being characterised by the dilution units described above.

The fuels can be further processed or refined by reformers. The fuel cell is distinguished in that it has in particular a plurality of electrochemical single cells and above all in that these single cells are disposed in a stack construction, the dilution unit being integrated in the stack.

The present invention is explained in more detail by the subsequently provided description in which reference is made also to the accompanying Figures. The subsequently discussed features should thereby in no way be understood such that the invention is restricted to the mentioned features.

There were thereby shown

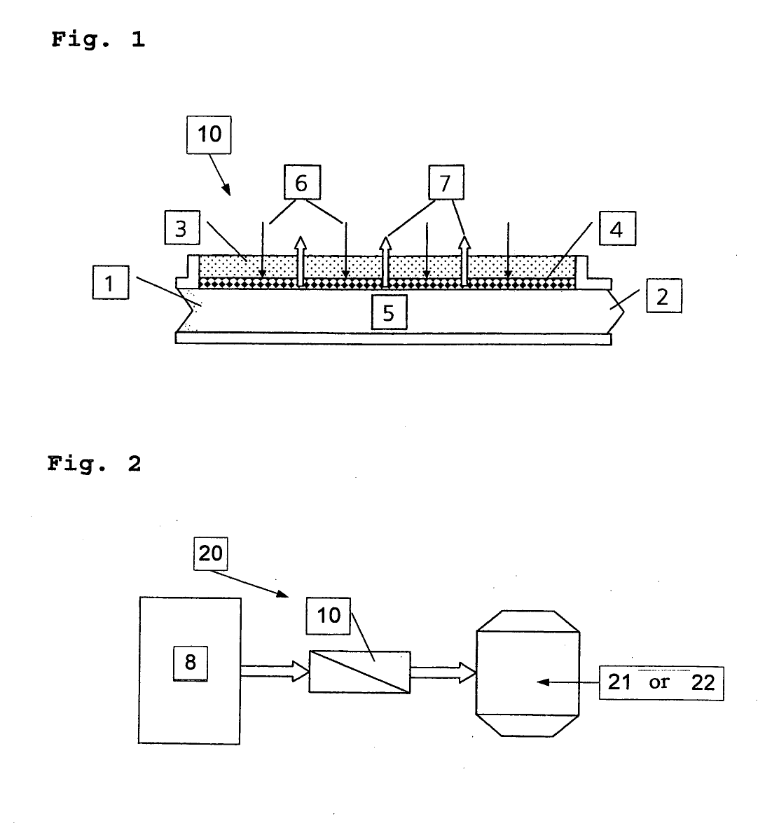

FIG. 1 the schematic construction of a passive dilution unit according to the invention and

FIG. 2 a unit further processing the diluted fuel, which unit, in addition to the fuel tank 8, has subsequently connected the dilution unit 10 and also, connected thereto, a technical processing plant.

There is proposed as a novel solution a dilution unit which, based on a separating phase coated on one side with catalyst, e.g. membrane or woven fabric, can produce water locally. For this purpose, the fuel is conducted through this unit and an oxidant, e.g. oxygen, can pass through the separation phase to the fuel (diffusively). On the fuel-side catalyst layer (e.g. platinum), a chemical reaction results in which inter alia water is produced as reaction product. This water is jointly transported in the fuel flow and has a diluting effect. In a subsequent unit which requires a diluted fuel, the latter is present in such a form. Gaseous reaction by-products can be eliminated again through the separating phase at the same time. The dilution unit is illustrated schematically subsequently in FIG. 1.

The dilution unit 10 thereby has a throughflow channel 5 for the fuel 1 which is highly concentrated on the inlet side. The wall of the throughflow channel is thereby formed on one side by the phase 3, the one on the fuel-side by the catalyst layer 4. Both the phase 3 and the catalyst layer 4 are thereby diffusively permeable for gases. It is hence made possible that for example oxidants 6, such as for example atmospheric oxygen, diffuse through the phase towards the catalyst layer and, via an oxidative reaction imparted by the catalyst, oxidise the latter there into water. On the other hand, it is also made possible as a result that reaction products 7 produced during the reaction, such as e.g. CO₂, can diffuse to the exterior both through the catalyst layer and the phase 3. Hence pollution or contamination of the fuel mixture by CO₂ is avoided. Since neither the catalyst layer 4 nor the phase 3 are permeable for water, the latter is retained in the throughflow channel 5 and hence mixed into the highly concentrated fuel. The fuel mixture 2 diluted with water then emerges from the throughflow channel 5. The membranes are selected here in particular from plastic materials, which are insensitive to fuel, coated woven fabrics, semi-permeable membranes, porous membranes, ion-exchanger membranes. In particular also the PTFE plastic materials Nafion®, Gore Select®, Flemion® and Fumion® are thereby applied.

This dilution unit can be used in technical processing plants, such as for example reformers or direct alcohol fuel cells. For this purpose, the dilution unit is connected between the fuel tank and the technical processing plant which requires a diluted fuel. A schematic representation can be seen in FIG. 2. A technical processing unit for further processing, e.g. for refining, or for consuming the fuel or fuel mixture diluted with water is illustrated here. The unit 20 thereby comprises a fuel tank 8 for the pure fuel or the highly concentrated fuel mixture, the dilution unit 10 according to the invention being connected to this tank via a pipe. The emerging, diluted fuel is thereafter supplied to a further unit which can be for example a reformer 21 which serves for fuel refining, or a fuel cell 22 which is operated especially with diluted fuels.

The proposed dilution unit is advantageous in particular for direct alcohol fuel cells. In standard stacked fuel cells, a dilution unit can be integrated into the stack such that the unit is positioned in front of the actual electrochemical cell. As a result of the fact that the unit is supplied with oxidants which are present in any case, for example atmospheric oxygen, there is no increased technical plant complexity. However it is possible with fuel cell systems in which such a unit is integrated to use highly concentrated fuel even if the electrochemical conversion unit actually demands lower concentrations. As a result, it emerges as an essential advantage for the fuel cell system that no additional water tank need be integrated and that no additional metering unit is required.

This construction proposed for stacked fuel cell systems can be transferred also to planar fuel cell systems.

The dilution unit according to the invention is hence used in general for diluting fuels, in particular in technical processing applications, such as for example during reforming processes or dilutions of fuel which is used for combustion in fuel cells. As an alternative thereto, a possibility for use in the foodstuffs industry is also conceivable, for example for diluting alcoholic concentrates.

1. Dilution unit (10) for passive dilution of fuels (1) with water, comprising:
a) at least one throughflow channel (5) for fuel (1),
b) the throughflow channel being configured at least in regions as a phase (3) having at least one catalyst (4).

2. Dilution unit (10) according to the preceding claim, characterised in that the phase (3) is selected from the group comprising membranes and/or woven fabrics.

3. Dilution unit (10) according to the preceding claim, characterised in that the membrane and/or the woven fabric is selected from the group comprising plastic materials resistant to the fuel, such as e.g. sPEEK, PEEK, PTFE; ceramic materials, coated woven fabrics, semi-permeable membranes, porous membranes and/or ion-exchanger membranes.

4. Dilution unit (10) according to claim 1, characterised in that the phase (3) is coated and/or impregnated with the catalyst (4).

5. Dilution unit (10) according to claim 1, characterised in that the catalyst (4) is selected from the group comprising platinum, tin, ruthenium, osmium, cobalt, iron, nickel, rhodium, copper, zinc, chromium and/or alloys and/or combinations hereof.

6. Dilution unit (10) according to claim 1, characterised in that the phase (3) is permeable diffusively for gases.

7. Dilution unit (10) according to the preceding claim, characterised in that the gases are selected from the group comprising gaseous oxidants (6), preferably oxygen or air and/or gaseous reaction products (7), preferably carbon dioxide.

8. Dilution unit (10) according to claim 1, characterised in that the phase (3) has reduced permeability for water, for the fuel (1) and/or for the fuel mixture and is preferably not permeable for water, for the fuel (1) and/or for the fuel mixture.

9. Method for passive dilution of a fuel (1) or of a fuel mixture (1′) with water,
a) a flow of a concentrated fuel (1) or of a concentrated fuel mixture (1′) being guided past a phase (3) having at least one catalyst (4) and thereby at least a part of the fuel (1) or of the fuel mixture (1′) being contacted with the phase (3) and the catalyst (4),
b) at least one oxidant (3) being supplied to the phase via diffusive processes, a part of the fuel (1) or of the fuel mixture (1′) being oxidised catalytically with water formation and
c) the water produced during the reaction diluting the fuel (1) or the fuel mixture (1′).

10. Method according to claim 9, characterised in that a dilution unit (10) is used.

11. Method according to claim 9, characterised in that the fuel (1) is selected from the group comprising liquid and/or gaseous fuels (1) and/or mixtures hereof.

12. Method according to claim 9, characterised in that the fuel (1) is selected from the group comprising hydrocarbons, such as e.g. natural gas, petrol, diesel, kerosene, methane, ethane, propane, butane, hydrogen, biogas, biodiesel, plant oils; alcohols, such as e.g. methanol, ethanol, denaturated alcohols, potable alcohol and/or mixtures hereof.

13. Method according to claim 9, characterised in that the oxidant (6) is selected from the group comprising atmospheric oxygen, oxygen and/or mixtures hereof.

14. Method according to claim 9, characterised in that by-products (7) produced during the reaction, such as e.g. carbon dioxide, diffuse away through the phase.

15. Method according to claim 9, characterised in that the fuel (1) or the fuel mixture (1′) is diluted up to the stoichiometrically required water content.

16. Reformer (21) containing a preceding dilution unit (10) according to claim 1 for further reprocessing of a fuel or fuel mixture diluted with water.

17. Fuel cell (22) containing a preceding dilution unit (10) according to claim 1 for oxidation of a fuel or fuel mixture diluted with water.

18. Fuel cell (22) according to the preceding claim, characterised in that the fuel cell (22) contains a plurality of electrochemical single cells.

19. Fuel cell (22) according to the preceding claim, characterised in that the fuel cell (22) contains a plurality of electrochemical single cells in a stack construction, the dilution unit (10) being integrated into the stack.

20. (canceled)
